(19) United States
(12) Patent Application Publication
(10) Pub. No.: US 2006/0220451 A1
(43) Pub. Date: Oct. 5, 2006

(54) Electrohydraulic brake system for motor vehicles

(75) Inventor: Stefan A. Drumm, Saulheim (DE)

Correspondence Address: CONTINENTAL TEVES, INC., ONE CONTINENTAL DRIVE, AUBURN HILLLS, MI, 48326-1581, US

(73) Assignee: Continental Teves AG & Co., oHG

(21) Appl. No.: 10/563,977

(22) PCT Filed: Jul. 9, 2004
(86) PCT No.: PCT/EP04/51446

§ 371 Date: Jan. 9, 2006

(30) Foreign Application Priority Data
Jul. 9, 2003 (DE) 103 30 977.2
Oct. 4, 2003 (DE) 103 46 117.5

(51) Int. Cl. B60T 8/44

(52) U.S. Cl. 303/114.1

(57) ABSTRACT

Disclosed is a brake system which can be operated in three modes of operation,a non-boosted mode of operation, a hydraulically boosted mode of operation, and an electronically controlled mode of operation. The brake system includes a master cylinder (1), a first piston (2) coupled to a brake pedal (3), a second piston (4) actuating the master cylinder (1), and a third piston (5) actuatable by the first piston (2), with at least one elastic element (6, 7) being provided between the first and the third piston (5), and all three pistons (2, 4, 5) are arranged in a housing (8). Further, there is provision of a hydraulic pressure source (9) and a valve device (10) for reducing the pressure of the pressure source (9) to a value of pressure that is fed into a space (11) by which the second piston (4) and the third piston (5) are separated from each other in such a fashion that the third piston (5) is acted upon by the pressure acting upon the second piston (4) in the direction being opposite to the direction of application of the second piston (4). A valve member (13) of the valve device (10) is designed so that its two end surfaces are exposed to the effect of pressure prevailing in the space (11).

### BACKGROUND OF THE INVENTION

The present invention relates to a brake system for motor vehicles that can be operated in a ‘brake-by-wire’ mode of operation, comprising: a master cylinder to which wheel brake cylinders can be connected, a first piston which is coupled to a brake pedal, a second piston which actuates the master cylinder, a third piston which can be operated by the first piston, with at least one brake pedal characteristics simulation device exerting a simulator force being provided between the first and the third piston and imparting a comfortable pedal feel to the operator in a by-wire mode of operation, and all three pistons and the brake pedal characteristics simulation device are arranged in a housing, with a hydraulic pressure source and a valve device for reducing the pressure of the pressure source to a value that is used for application of the second piston, and the second and the third piston are isolated from each other by a space in such a fashion that the third piston is acted upon by the pressure that acts on the second piston in the direction opposite to the direction of application of the second piston.

Brake-by-wire systems are being used at an increasing rate in motor vehicle technology. The brake in these brake systems can be actuated independently by way of electronic signals without any action on the driver's part. These electronic signals may e.g. be output from an electronic stability program ESP or a collision avoidance system ACC. When an actuation by the driver is superposed on such an independent actuation, the driver of the motor vehicle feels a reaction in the brake pedal. This reactive effect on the brake pedal can be unusual or unpleasant to the driver so that the driver will not apply the brake pedal in a critical situation of traffic as intensely as would be necessary in this situation because he/she is irritated by the reaction which the independent actuation of the brake produces at the brake pedal.

EP 1 078 833 A1 describes an electrohydraulic brake system of the type mentioned hereinabove. The valve device for reducing the pressure of the pressure source in the prior art brake system is configured as a slide valve that can be operated mechanically by means of a tilting lever, the slide of which is displaceably guided in a bore provided in the housing. In order to mount both the slide and a compression spring preloading it, the bore is open towards the atmosphere so that there is a risk of leakage in this area which can cause contamination of the vehicle's interior.

### SUMMARY OF THE INVENTION

In view of the above, an object of the invention is to provide a brake system of the type referred to hereinabove in which the above-mentioned risk of leakage into the interior of the vehicle is eliminated to a great extent. Another objective is that the brake system has a simple design and allows manufacture at low costs.

According to the invention, this object is achieved in that both end surfaces of a valve member of a valve device are exposed to the effect of the pressure that prevails in the space.

### BRIEF DESCRIPTION OF THE DRAWINGS

Examples of the embodiments of the invention will be explained in detail in the following by making reference to the accompanying schematic drawings. In the drawings:

FIG. 1 shows the design of the brake system of the invention in the rest condition according to a first embodiment;

FIG. 2 shows the brake system of the invention according to FIG. 1 during a pressure-maintenance phase of an ‘independent’ braking operation irrespective of the driver's request;

FIG. 3 shows the brake system of the invention according to FIG. 1 during a pressure-maintenance phase of a preferred ‘brake-by-wire’ braking operation;

FIG. 4 shows the brake system of the invention according to FIG. 1 during failure of the electric current supply or in the so-called hydraulic fallback mode;

FIG. 5 shows the brake system of the invention according to FIG. 1 during failure of the pressure source or in the so-called mechanical fallback mode;

FIG. 6 shows the design of a second embodiment of the brake system of the invention in the rest condition;

FIG. 7 shows a third embodiment of the brake system of the invention in the rest condition, and

FIG. 8 shows a fourth embodiment of the brake system of the invention in the rest condition.

### DETAILED DESCRIPTION OF THE DRAWINGS

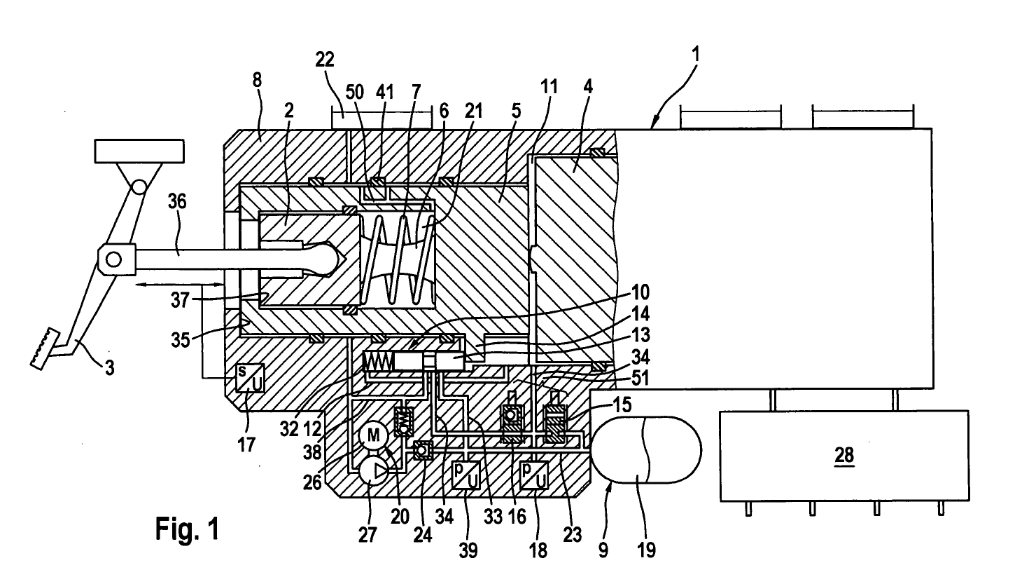

FIG. 1 shows the brake system of the invention in the rest condition. The brake system includes a brake pedal 3 which is rigidly connected to a first piston 2 by way of an actuating rod 36. The brake pedal travel can be sensed by means of a travel sensor 17. The first piston 2 is arranged in a third piston 5, and a hydraulic chamber 21 is arranged between the first and the third piston in which elastic elements 6, 7 forming a brake pedal characteristics simulation device bring about a coupling between the first (2) and the third piston 5.

Further, a second piston 4 is provided which is associated with a master cylinder 1 and permits pressure buildup therein. The master cylinder 1 is connected to wheel brakes (not shown) of the vehicle by way of an electrohydraulic control or regulation unit 28 (only represented) of an anti-lock system (ABS).

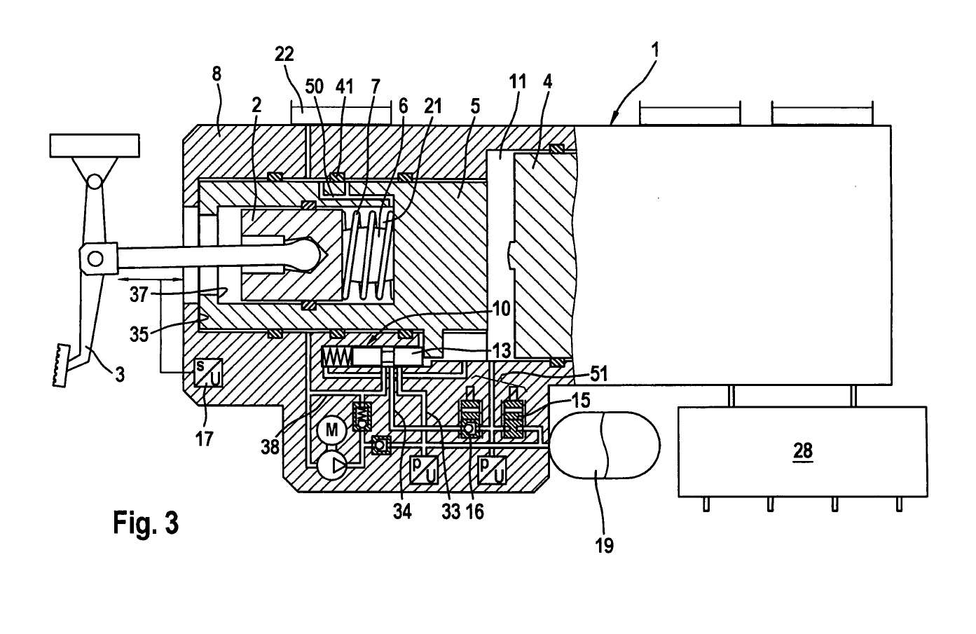

The first (2), the second (4) and the third piston 5 are accommodated in a housing 8. A space 11 which can be filled with pressure fluid is interposed between the third piston 5 and the second piston 4. The pressure in the space 11 is controlled in a preferred ‘brake-by-wire’ mode of operation (see FIG. 3) in the following fashion: when applying the brake pedal 3, the driver moves the first piston 2 in opposition to the spring force of the elastic elements 6 and 7. The elastic elements 6 and 7 are so configured that they impart to the driver the brake feel which corresponds to a customary brake pedal characteristics. This means that with a short brake pedal travel, the resistance rises slowly, while it grows over-proportionally with a longer brake pedal travel. By applying the brake pedal 3, the third piston 5 can now also be moved in the direction of the second piston 4, with the result that a first valve device 10 is actuated already after a very short displacement travel. The first valve device 10 in the illustrated example is configured as a hydro-mechanical booster valve which includes a valve member 13 that is preloaded by means of a spring 32 in the direction of the second piston 4 and includes two control edges, whose purpose will be explained in the following text. A hydraulic connection 12 which, as is illustrated, is designed in the housing 8 or, alternatively, is formed of a non-illustrated axial through-bore in the valve member 13 allows the application of the pressure introduced into the space 11 to the end surface of the valve member 13 remote from the space 11. In this arrangement, the valve member 13 interacts with an actuating element which is configured as a radial projection 14 shaped at the third piston 5 in the embodiment shown. When the third piston 5 moves slightly in the direction of the second piston 4, the valve member 13 will follows its movement until a connection is established between the space 11 and a hydraulic pressure source 9. This connection is established in that the right-hand control edge of the valve member 13 as shown in the drawing opens the flow path between a hydraulic pressure line 23 leading from the pressure source 9 or a line portion 33 branching therefrom and a pressure fluid channel 34 opening into the space 11. The hydraulic pressure source 9 is preferably formed of a high-pressure accumulator 19 being charged by a motor-and-pump assembly 20. The motor-and-pump assembly 20 comprises an electric motor 26 and a hydraulic pump 27 whose suction side is connected to an unpressurized pressure-fluid supply reservoir 22, while its pressure side is in connection to the high-pressure accumulator 19 through the above-mentioned conduit 23. Inserted into conduit 23 is a non-return valve 24 that opens towards the high-pressure accumulator 19, and a pressure sensor 39 allows monitoring the charging condition of the high-pressure accumulator 19. The high-pressure accumulator 19 supports the pump 27 mainly in those cases in which pressure build-up is required in a short time, for example in the case of quick emergency braking, which pressure cannot be provided instantaneously by the pump 27 due to its mass inertia. By means of the connection between the high-pressure accumulator 19 and the space 11, the latter is acted upon by pressure, with the result that the second piston 4 in the master cylinder 1 builds up pressure and the third piston 5 is urged in the direction of a stop 35 in the housing 8, on which it abutted before the brake was applied. A second valve device 51 is composed of a valve 15 connected to the high-pressure accumulator 19, a pressure increase valve which is closed in the de-energized condition, and a valve 16 inserted into the pressure fluid channel 34, i.e. a separating valve in the illustrated embodiment which is open in the de-energized condition so that the pump 27 or the high-pressure accumulator 19 can apply pressure to the space 11 by way of the connection explained hereinabove. A pressure sensor 18 can sense the pressure introduced into the space 11. Energization of the separating valve 16 allows precluding the discharge of pressure fluid out of the space 11 through the valve device 10, while pressure fluid can be introduced into the space 11 by way of energization of the pressure increase valve 15.

In the non-applied condition of the brake pedal 3 (see FIG. 1) the first piston 2 is urged against a stop 37 by way of the elastic elements 6 and 7, said stop being provided in the third piston 5.

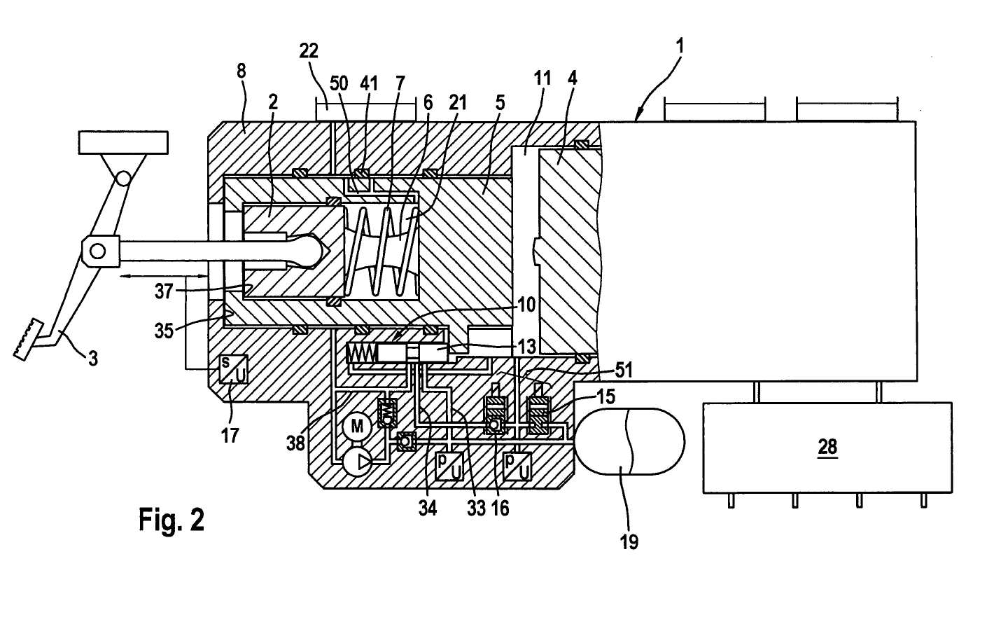

In the first mode of operation, the pressure-maintenance phase of which is illustrated in FIG. 2 and which is characterized by a brake operation independent of the driver's request, actuation of the second valve device 51 causes the actuating pressure in the space 11 to be adapted to a nominal pressure value with is continuously re-calculated. To this end, energization of the separating valve 16 permits interrupting the volume flow to the valve device 10, while the possibility of the reverse volume flow from the first valve device 10 through the separating valve 16 for pressure increase in the space 11 is maintained. An actuating pressure being higher than the pressure which would be predetermined by the hydro-mechanical booster valve, i.e. valve device 10, can be adjusted in an electronically controlled fashion by way of the pressure increase valve 15. The energization of the separating valve 16 is temporarily discontinued for the purpose of electronically controlled pressure reduction, so that pressure fluid can discharge to the first valve device 10 which establishes a connection to the pressure fluid supply reservoir 22 in this operating state. This connection is established because the control edge of the valve member 13 being on the left-hand side in the drawing opens the flow path between the pressure fluid channel 34 and a hydraulic connection 38 leading from the first valve device 10 to the pressure fluid supply reservoir 22. This electronic brake pressure control is advantageous because its transmission performance can be freely selected within the limits of the dynamics given by the technical data of high-pressure accumulator, pressure increase valve and separating valve. Therefore, a so-called jump function, i.e. jumping to a predetermined brake pressure value when touching the brake pedal 3, a brake assist function, a deceleration control and an autonomous brake operation, as it is required e.g. for TCS (Traction Slip Control), ESP (Electronic Stability Program) and ACC (Adaptive Cruise Control), can be realized by software measures. To this end, the driver's specification in the form of a brake pedal application which is sensed by travel sensors, force sensors, or other types of sensors, is converted into wheel brake pressures by a calculating unit (not shown) by using appropriate algorithms, the latter pressures being realized by means of the electronically controllable valves in the independent force braking module and the subsequent ABS hydraulic unit.

In the second mode of operation, the ‘brake-by-wire’ mode, whose pressure maintenance phase is shown in FIG. 3 and which is characterized by an independent brake operation initiated by the driver's deceleration request, hydraulic pressure is controlled in the space 11 by a corresponding actuation of the valves 15, 16 in response to the signal of the travel sensor 18 sensing the driver's request. The pressure increase valve 15 remains de-energized in the pressure-maintenance phase shown in FIG. 3, while the separating valve 16 is energized and maintained in it closed position. In all other respects the ‘brake-by-wire’ mode of operation in electrohydraulic brake systems is known in the art and, therefore, need not be discussed in detail.

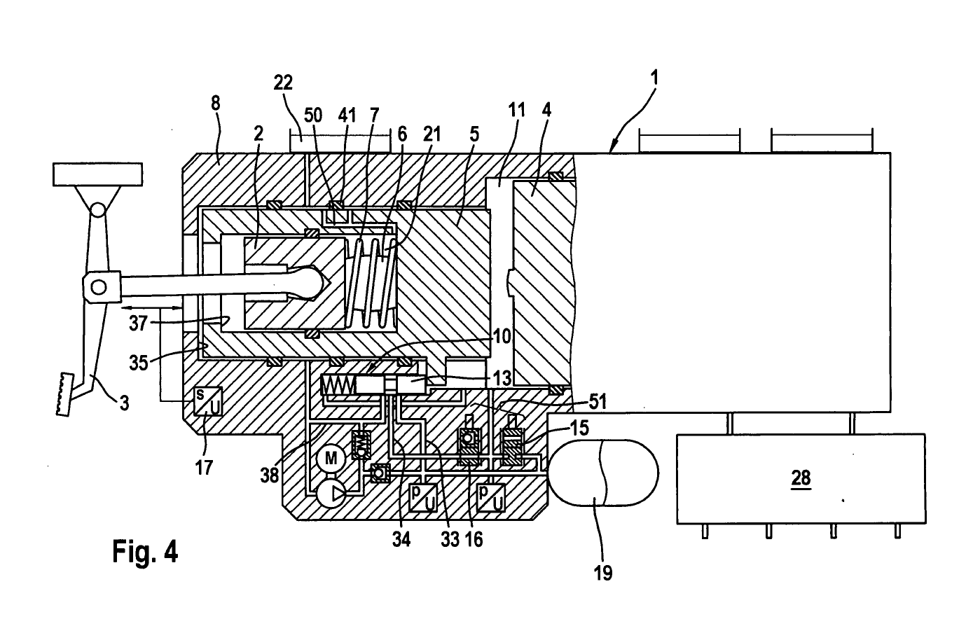

In the third mode of operation (see FIG. 4) which is characterized by failure of the electric current supply or the so-called hydraulic fallback mode, the electromagnetic valves 15 and 16 remain de-energized. This enables the valve device 10, i.e. the hydro-mechanical booster valve, to control the actuating pressure in the space 11 and, thus, bring about brake force boosting. As this occurs, pressure increase is controlled by the interaction between the control edge of the valve member 13 which is on the right-hand side of the drawing and the line portion 33, while pressure reduction is controlled by the interaction between the control edge that is on the left-hand side in the drawing and the hydraulic conduit 38. Hydraulic boosting functions without electricity as long as the high-pressure accumulator 19 can supply pressurized pressure fluid. There is a linear power boosting, the boosting factor of which is invariably predetermined by the ratio between the cross-sectional surfaces of second piston 4 and third piston 5.

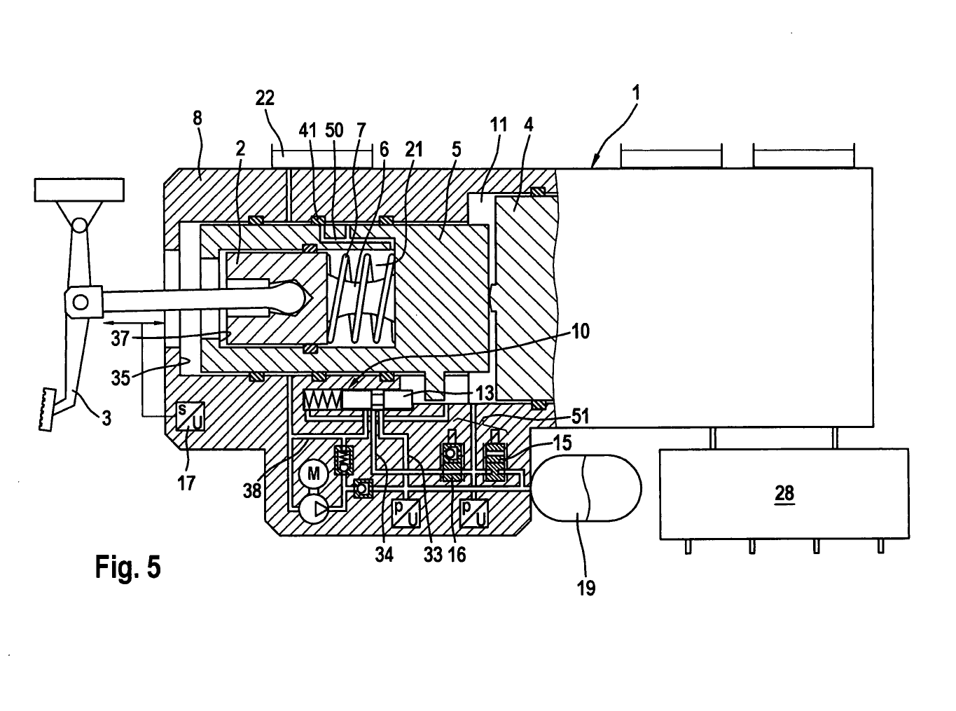

In the fourth mode of operation which is characterized by the lack of hydraulic pressure in the pressure accumulator 19 or the so-called mechanical fallback mode (see FIG. 5), the brake system can be operated in a purely mechanically fashion, the third piston 5 moves under the effect of an actuating force introduced at the brake pedal 3 away from its stop 35 and displaces the second piston 4 by way of mechanical force transmission so that the actuation of the master cylinder 1 takes place exclusively by muscular power. The relative movement of the third piston 5 taking place with respect to the housing 8 causes closing of the above-mentioned hydraulic chamber 21 because the port of a conduit 50 connected to the hydraulic chamber 21 overrides a stationary seal 41 arranged in the housing 8. This closure enables deactivation of the function of the brake pedal characteristics simulation device 6, 7 so that a direct force transmission takes place from the first (2) to the third piston 5.

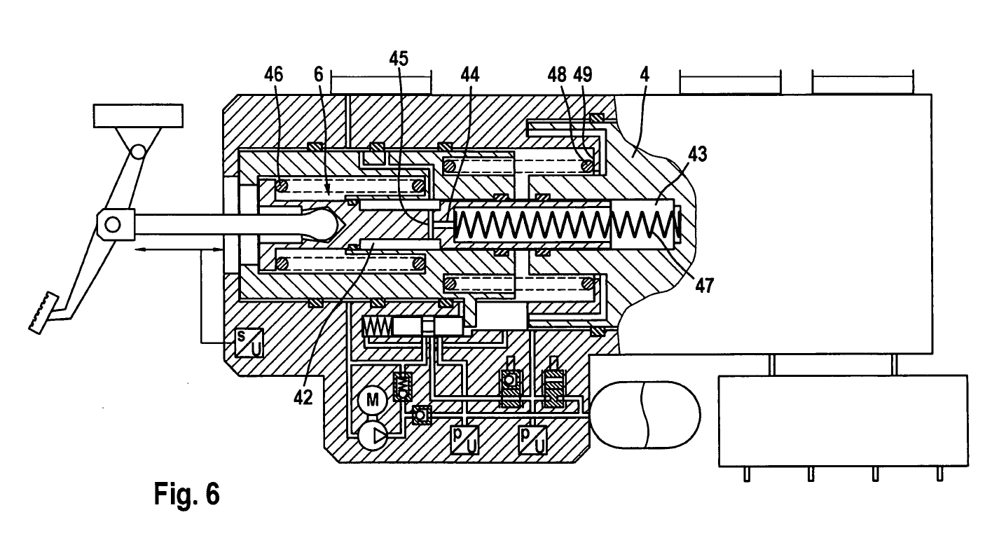

FIG. 6 depicts a second embodiment of the invention wherein the above-mentioned hydraulic chamber 21 is limited by the first piston 2 partly in the third piston 5 and partly in the second piston 4. The hydraulic connection between the part 42 of chamber 21 designed in the third piston 5 with its part 43 designed in the second piston 4 takes place through bores 44, 45 which are provided vertically to each other in the first piston 2, while the above-mentioned elastic element 6 of the brake pedal characteristics simulation device or a compression spring 46 is arranged outside the hydraulic chamber 21 (or 42) and, thus, remains dry. A second compression spring 47 supporting the effect of compression spring 46 is supported on the first piston 2, on the first hand, and on the second piston 4, on the other hand. A third compression spring 48 biases the third piston 5 in opposition to the actuating direction of the brake system and is supported on an abutment surface 49 provided in the housing 8.

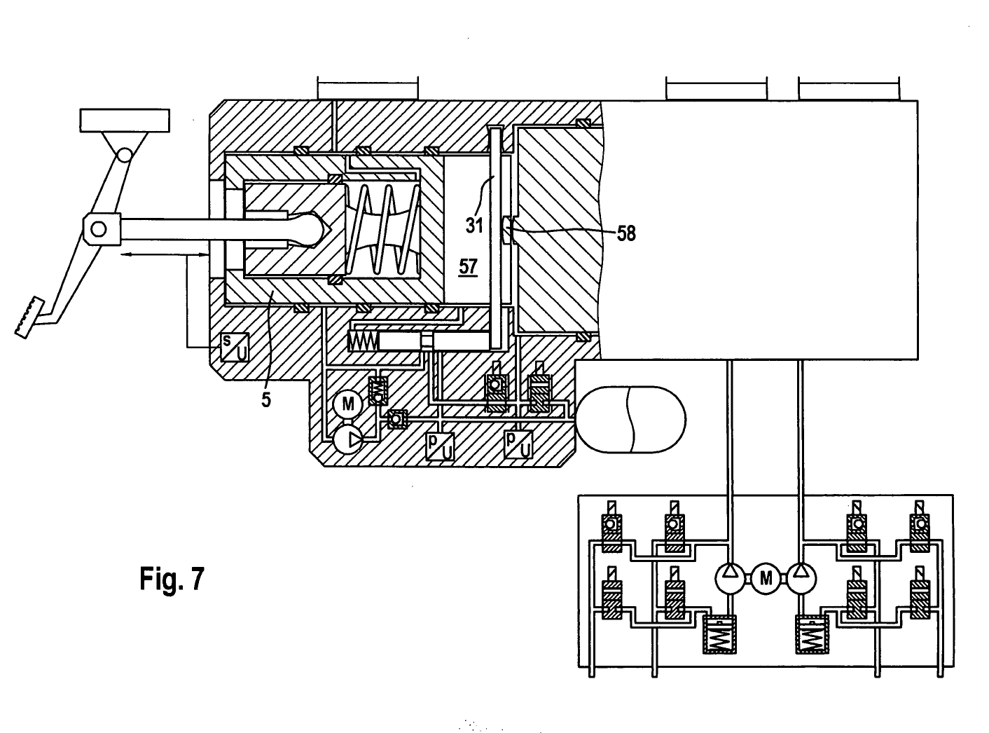

In a third embodiment of the brake system of the invention as illustrated in FIG. 7, the actuation of the valve device 10 occurs by way of a lever or cross bar 31 cooperating with the third piston (5). The cross bar 31 which is in a force-transmitting connection to the valve member 13 is mounted in the housing 8, extends in the rest condition preferably vertically to the longitudinal axis of the third piston 5 through a recess 53 provided in the third piston 5 and, under the effect of the spring 32 mentioned hereinabove, is supported in the type of a two-arm lever on a projection 54 provided on the third piston 5.

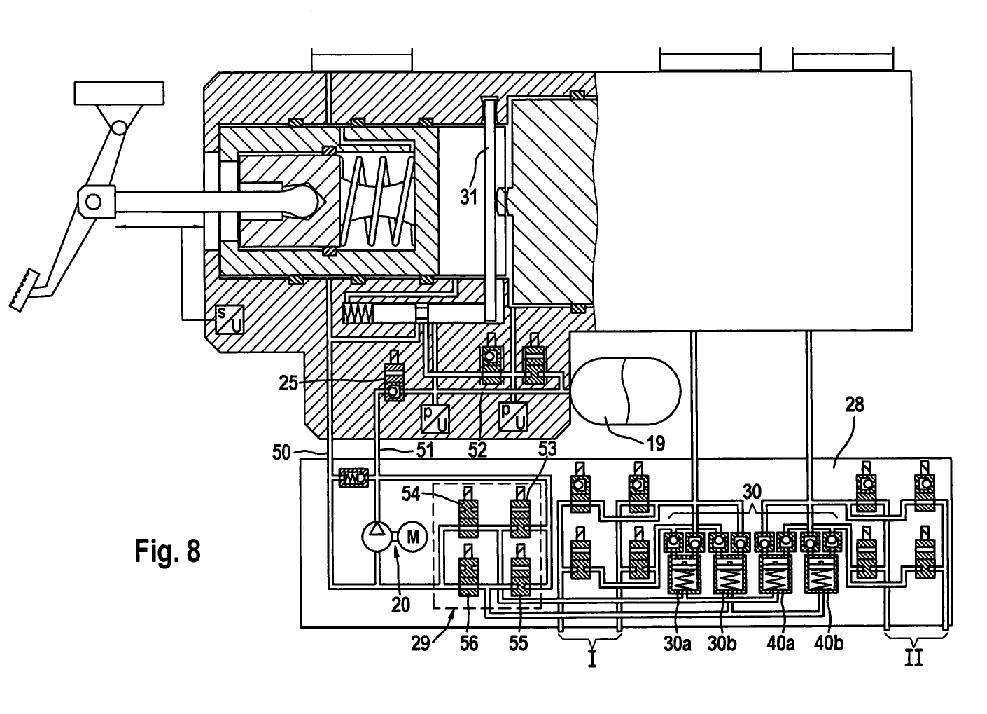

In a fourth embodiment of the brake system of the invention as illustrated in FIG. 8, the motor-and-pump assembly 20 is integrated in the above-mentioned electrohydraulic control or regulation unit 28. The suction side of the pump 27 is supplied with pressure fluid under atmospheric pressure through a first hydraulic connection 50 arranged between the housing 8 and the control or regulation unit 28 leading to the pressure fluid supply reservoir 22. The pressure fluid which is supplied by the pump under high pressure is conducted to the high-pressure accumulator 19 through a second hydraulic connection 51 arranged between the control or regulation unit 28 and the housing 8 and a connecting portion 52 that extends within the housing 8 and leads to the high-pressure accumulator 19. In this arrangement, an electrically controllable valve 25, preferably a two-way/two-position directional control valve, is inserted into the connecting portion 52, said valve fulfilling in a first switch position the function of a non-return valve that opens towards the high-pressure accumulator 19, while it opens the hydraulic connection 51 in a second switch position. When the connection 51 has been opened, the control or regulation unit can be furnished with hydraulic energy from the high-pressure accumulator 19, with the motor-and-pump assembly 20 inoperative or not yet operative. When this feature is omitted, the electrically controllable valve 25 may be replaced by a non-return valve.

Further, the electrohydraulic control or regulation unit 28 comprises a device 30 for the return delivery of excessive pressure fluid volume being produced in anti-lock control operations into the master brake cylinder 1. The return delivery device 30 which can be driven by the pressure generated by the motor-and-pump assembly 20 and by the pressure prevailing in the high-pressure accumulator 19 is provided by at least two low-pressure accumulators 30a, 30b, 40a, 40b which alternately take up prevailing pressure fluid volume or displace the prevailing pressure fluid volume under the effect of the driving pressure into the master brake cylinder 1 in the sense of a return delivery. Two groups of low-pressure accumulators 30a, 30b and 40a, 40b are provided in the illustrated design, and one pair of low-pressure accumulators 30a, 30b; 40a, 40b is respectively associated with each brake circuit I, II in such a fashion that each of the brake circuits I and II comprises one low pressure accumulator related to group a and one related to group b. High pressure produced by the above-mentioned motor-and-pump assembly 20 can be applied to the low-pressure accumulators 30a, 30b, 40a, 40b on their side remote from the low-pressure ports so that the pressure fluid volume contained on the brake circuit part can be returned into the master brake cylinder 1. In this arrangement, the two groups 30a, 40a, or 30b, 40b, respectively, operate cyclically according to the pattern:
return delivery of the first group 30a, 40a,
no return delivery,
return delivery of the second group 30b, 40b,
no return delivery.

Pressure application is controlled by means of a valve device 29 associated with the motor-and-pump assembly 20 in such a fashion that at least one low-pressure accumulator per brake circuit is at any time in a position to take up the pressure fluid which is discharged from the pressure control valves (not referred to in detail) comprised in the electrohydraulic control or regulation unit 28. The valve assembly 29 is preferably comprised of four valves 53, 54, 55, 56 which, in the type of a H bridge circuit, are connected in such a fashion that the valve pair 53, 54 is associated with the first low-pressure accumulator group 30a, 40a and the valve pair 55, 56 is associated with the second low-pressure accumulator group 30b, 40b. Change-over of the valves 53, 55 causes application of independent pressure to the low-pressure accumulator groups, while change-over of the valves 54, 56 causes the low-pressure accumulator groups to be connected to the pressure fluid supply reservoir 22, that means to the atmospheric pressure, by means of the above-mentioned hydraulic connection 50.

An electronic control unit (not shown) which preferably forms a construction unit in conjunction with the control or regulation unit 28 is used to actuate all valves mentioned before and the electric motor 26, and the output signals of the sensors 17, 18 and 39 are sent as input information to the electronic control unit.

1-36. (canceled)

37. An electrohydraulic brake system for a motor vehicle which can be operated in a ‘brake-by-wire’ mode of operation, comprising:
a master cylinder (1) connectable to wheel brake cylinders;
a first piston (2) coupled to a brake pedal (3),
a second piston (4) for actuating the master cylinder (1),
a third piston (5) which can be operated by the first piston (2), with at least one brake pedal characteristics simulation device (6, 7) for exerting a simulator force being provided between the first (2) and the third piston (5) and imparting a comfortable pedal feel to an operator in a by-wire mode of operation, wherein the first piston, the second piston, the third piston and the travel simulator device are arranged in a housing (8),
a hydraulic pressure source (9); and
a valve device (10) operable by the third piston (5) for reducing a pressure of the pressure source (9) to a value used for application of the second piston (4), wherein the second (4) and the third piston (5) are isolated from each other by a space (11) so that the third piston (5) is acted upon by the pressure that acts on the second piston (4) in a direction opposite to a direction of application of the second piston (4); and
a valve member (13) of the valve device has both end surfaces exposed to an effect of the pressure that prevails in the space (11).

38. The brake system according to claim 37, wherein an end surface of the valve member (13) is exposed to the effect of the pressure prevailing in the space (11) by way of a hydraulic connection (12) provided in the housing (8).

39. The brake system according to claim 37, wherein two end surfaces of the valve member (13) communicate with each other through a longitudinal bore in the valve member (13).

40. The brake system according to claim 37, wherein moving directions of the valve member (13) and the third piston (5) upon actuation of the valve device (10) by the third piston (5) are identical.

41. The brake system according to claim 37, wherein the valve member (13) can be actuated directly by the third piston (5).

42. The brake system according to claim 41, wherein the third piston (5) includes a radial projection (14) which cooperates in a force-transmitting fashion with the end surface of the valve member (13) facing the space (11).

43. The brake system according to claim 37, wherein the valve member (13) is operable by a lever or cross bar (31) which cooperates with the third piston (5), is mounted in the housing (8) and arranged preferably vertically to the longitudinal axis of the third piston (5).

44. The brake system according to claim 37, wherein the hydraulic pressure source (9) is formed of a high-pressure accumulator (19) which can be charged by a motor-and-pump assembly (20).

45. The brake system according to claim 44, wherein a second valve device (15, 16) that is electrically operable by means of an electronic control unit is used to influence the pressure that is to be introduced into the space (11) and is integrated in the housing (8).

46. The brake system according to claim 44, wherein a pressure sensor (39) is provided to monitor a charging condition of the high-pressure accumulator (19), whose output signal is sent to the electronic control unit and which is integrated in the housing (8) or form-lockingly connected to the housing.

47. The brake system according to claim 44, wherein a pressure sensor (18) is provided to sense the pressure that prevails in the space (18), whose output signal is sent to the electronic control unit and which is integrated in the housing (8) or form-lockingly connected to the housing.

48. The brake system according to claim 44, wherein the high-pressure accumulator (19) is arranged directly at the housing (8), and a hydraulic connection (23) between the pressure side of a pump (27) of the motor-and-pump assembly (20) and the high-pressure accumulator (19) is formed by at least one bore provided in the housing (8).

49. The brake system according to claim 48, wherein a non-return valve (24) opening towards the high-pressure accumulator (19) is inserted into the hydraulic connection (23).

50. The brake system according to claim 37, wherein an electronic control or regulation unit (28) of an anti-lock system (ABS) is connected to the master brake cylinder (1).

51. The brake system according to claim 50, wherein the electrohydraulic control or regulation unit (28) operates according to the return delivery principle and includes a device (30) for the return delivery of excessive pressure fluid volume into the master brake cylinder (1).

52. The brake system according to claim 50, wherein the motor-and-pump assembly (20) is integrated into the electrohydraulic control or regulation unit (28).

53. The brake system according to claim 52, wherein pressure fluid under atmospheric pressure is supplied to the pump (27) through a first hydraulic connection (50) arranged between the housing (8) and the control or regulation unit (28), and the pressure fluid discharged under high pressure from the pump (27) is conducted through a second hydraulic connection (51) being arranged between the control or regulation unit (28) and the housing (8) to a portion (52) of the hydraulic connection (23) that extends within the housing (8) and leads to the high-pressure accumulator (19).

54. The brake system according to claim 53, wherein a non-return valve opening to the high-pressure accumulator (19) is inserted within the portion (52).

55. The brake system according to claim 54, wherein the depth of the profile of the tire is taken into consideration in the assessment of the frequency curve in the driving operation.

56. The brake system according to claim 54, inserted within the portion (52) is an electrically controllable valve (25), preferably a two-way/two-position directional control valve, which fulfills the function of a non-return valve opening towards the high-pressure accumulator (19) in a first switch position and opens the hydraulic connection (51) in a second switch position.

57. The brake system according to claim 52, wherein the device (30) for the return delivery of excessive pressure fluid volume can be driven by the pressure generated by the motor-and-pump assembly (9).

58. The brake system according to claim 52, wherein the device (30) for the return delivery of excessive pressure fluid volume can be driven both by the pressure generated by the motor-and-pump assembly (20) and by the pressure prevailing in the high-pressure accumulator (19).

59. The brake system according to claim 58, wherein the device (30) is provided by at least two low-pressure accumulators (30a,b; 40a,b) which alternately take up prevailing pressure fluid volume or displace the prevailing pressure fluid volume under the effect of the driving pressure in the sense of a return delivery.

60. The brake system according to claim 58, wherein the motor-and-pump assembly (20) or the high-pressure accumulator (19) in conjunction with the electrically controllable valve (25) cooperates with a valve device (29) which alternately provides the driving pressure or the atmospheric pressure for the low-pressure accumulators (30a,b; 40a,b).

61. The brake system according to claim 60, wherein the valve device (29) is integrated into the electrohydraulic control or regulation unit (28).

62. The brake system according to claim 37, wherein the brake pedal characteristics simulation device has at least one elastic element (6, 7) which exerts a ‘spring force’ component of the simulator force that depends on the relative travel between the first (2) and the third piston (5).

63. The brake system according to claim 62, wherein the brake pedal characteristics simulation device has at least one damping device which exerts a damping force component of the simulator force that depends on a relative speed between the first (2) and the third piston (5).

64. The brake system according to claim 62, wherein the brake pedal characteristics simulation device (6, 7) comprises at least one of the components steel spring, elastomeric body, and frictional connection, exerting the simulator force.

65. The brake system according to claim 62, wherein the brake pedal characteristics simulation device (6, 7) can be blocked in such a manner that it prevents a movement of the first piston (2) relative to the third piston (5) in the actuating direction which exceeds the existing piston positions.

66. The brake system according to claim 65, wherein the brake pedal characteristics simulation device (6, 7) is blocked in dependence on the relative travel of the third piston (5) with respect to the housing (8).

67. The brake system according to claim 66, wherein the brake pedal characteristics simulation device cooperates with a hydraulic chamber (21) that is limited by the first piston (2) in the third piston (5) and is in connection to an unpressurized pressure fluid supply reservoir (22) through another hydraulic connection (50) and which can be closed by a relative movement of the third piston (5) relative to the housing (8)

68. The brake system according to claim 67, wherein the brake pedal characteristics simulation device cooperates with a hydraulic chamber (42, 43, 44, 45) that is limited by the first piston (2) in the third piston (5) and is in connection to the unpressurized pressure fluid supply reservoir (22) and which can be closed by a relative movement of the third piston (5) relative to the housing (8).

69. The brake system according to claim 62, wherein wherein the brake pedal characteristics simulation device (6, 7) can be blocked in so that it prevents in the a movement of the first piston (2) relative to the second piston (4) in the actuating direction which exceeds the existing piston positions.

70. The brake system according to claim 62, wherein some damping of the brake pedal characteristics simulation device (6, 7) is achieved by a corresponding dimensioning of a hydraulic connection (50) between the hydraulic chamber (42, 43, 44, 45) and the unpressurized pressure fluid supply reservoir (22).

71. The brake system according to claim 70, wherein the damping of the brake pedal characteristics simulation device (6, 7) is achieved by a hydraulic damping device inserted into the hydraulic connection (50).

72. The brake system according to claim 71, wherein the damping device comprises hydraulic orifices and includes a damping characteristic which depends on the direction of flow.

73. The brake system according to claim 62, wherein the components exerting the simulator force are arranged in each case either outside (‘dry’) or inside (‘wet’) the hydraulic chamber (21)
